(19) United States
(12) Patent Application Publication
(10) Pub. No.: US 2010/0179852 A1
(43) Pub. Date: Jul. 15, 2010

(54) EMR Template for Workflow Management and Workflow Information Capture

(76) Inventors: Frank Morito Tomizuka, Tucson, AZ (US); Bennet E. Davis, Tucson, AZ (US)

Correspondence Address: LAWRENCE R. OREMLAND, P.C., 5055 E. BROADWAY BLVD., SUITE C-214, TUCSON, AZ, 85711, US

(21) Appl. No.: 12/377,120

(22) PCT Filed: Aug. 13, 2007
(86) PCT No.: PCT/US07/75796

§ 371 Date: Feb. 10, 2009

Related U.S. Application Data
(60) Provisional application No. 60/837,017, filed on Aug. 11, 2006.

(51) Int. Cl. G06Q 10/00; G06Q 50/00; G06F 17/00

(52) U.S. Cl. 705/9; 715/234

(57) ABSTRACT

A new and useful EMR template functionality for workflow management and workflow information capture is provided. The EMR template functionality is configured with the following characteristics; (a) user configurable workflow specific structured language options, (b) the ability to be kept open to changes and new inputs across the process to which the template refers, (c) the ability to enable selection of a user or user group as a responsible actor in the workflow, (d) the capability to distinguish the template from all other templates (without described workflow functionality) associated with the EMR, and (e) workflow specific searchable data fields. Thus, the template can be configured not only to provide patient medical information, but also to capture workflow information (e.g. insurance authorization, procedure scheduling, etc.), which enables the EMR to track a patient process over time, with regard, e.g. to the state of the workflow ordered for the patient, and thereby gives a medical office or other treatment environment an effective management tool to manage the medical office or other treatment environment's function and to provide effective patient care.

### RELATED APPLICATION/CLAIM OF PRIORITY

This application is related to and claims priority from provisional application Ser. No. 60/837,017, filed Aug. 11, 2006, which provisional application is incorporated by reference herein.

### BACKGROUND

The present invention relates to new and useful electronic medical records (EMR) template for workflow management and workflow information capture.

The present invention provides an EMR template designed for workflow (or process) specific management, e.g. of a medical office or other treatment environment, designed to effectively manage, document and coordinate workflow surrounding both clinical and administrative patient management processes in a medical setting. For several years, it has been useful to physicians and their staffs (referred to herein as “medical offices or other treatment environments”) to implement various forms of electronic medical records (EMR) systems. One known EMR system is provided by Misys Healthcare Systems. That system is promoted by Mysis as providing advantages such as reducing overhead and improving efficiency for a medical office or other treatment environment. In the applicants' experience, the Mysis EMR has utility and application functions that are useful to a medical office or other treatment environment. The Mysis EMR system also includes a template format, and a template builder tool, by which a template can be customized. However, applicants' experience is also that the Mysis and other existing EMRs can benefit from an EMR template that is designed with improved functionality that applicants believe would make it more attractive to a medical office or other treatment environment, and also improve its ability to promote and manage patient care.

For example, applicants believe that an EMR can be particularly useful in the management of healthcare delivery by providing features such as, e.g.:

a. enabling creation of user defined information that describes the workflow and allows the template to continuously describe the state of the workfow across the process the particular template refers to.

b. enabling creation of user defined searchable fields that characterize the state of the workflow across the process the particular template refers to ; which fields may change during the management of a workflow, and may comprise, e.g. fields such as Initial, Awaiting response, Awaiting Patient Response, Patient Dependent Constraint, Practice Dependent Constraint, Scheduled, Completed.

c. Enabling the creation of user defined, searchable data fields that denote a user or group of users that are responsible for handling the workflow.

### SUMMARY OF THE INVENTION

The present invention provides a new and useful EMR template for workflow management and workflow information capture, that is designed to provide the foregoing features, and provide addition management capability to an EMR.

An EMR template for workflow management and workflow information capture, according to the principles of the present invention , is configured with the following characteristics; (a) user configurable workflow specific structured language options, (b) the ability to be kept open to changes and new inputs over time, (c) the ability to enable selection of a user or user group as a responsible actor in the workflow, (d) the capability to distinguish the template from all other templates (without described workflow functionality) associated with the EMR, and (e) workflow specific searchable data fields.

An EMR template, according to the present invention, is preferably designed such that the workflow specific structured language options at least include structured language options relating to authorization and scheduling workflow management functions. This feature is designed to be particularly effective in providing effective workflow management capability to an EMR.

For example, an EMR template according to the present invention is designed to provide an effective documentation system, both for the patient and the medical office or other treatment environment, and also for providing an administrative (management) entry and tracking functionality, e.g. by providing an efficient way to administer (manage) the patient information and workflow in a medical office or other treatment environment, and by enabling the medical office or other treatment environment to track the status of authorization, scheduling and processing for a patient, the medical office or other treatment environment can improve its efficiency, and also provide effective patient care.

Other features of the present invention will become further apparent from the following detailed description and the accompanying drawings.

### BRIEF DESCRIPTION OF THE DRAWINGS AND EXHIBIT

FIG. 1 is a schematic illustration of an EMR system with a template according to the principles of the present invention;

FIG. 2 is a schematic illustration of a portion of a template according to the principles of the present invention;

FIG. 3 is a schematic illustration of the manner in which an EMR system implementing the principles of the present invention can process patient related encounters, based on the work group and work list provided as part of the electronic template; and

FIGS. 4-8 are screen captures of certain features associated with a template according to the principles of the present invention.

Exhibit A comprises copies of materials published, on line, by Mysis, and providing additional information about the hardware requirements and functionality of the Mysis EMR system.

### DETAILED DESCRIPTION

As discussed above, the present invention relates to a new and useful EMR template functionality for workflow management and workflow information capture, that is designed to provide the foregoing features, and provide additional management capability to an EMR template. An EMR template, according to the principles of the present invention, is believed particularly useful in EMR system such as the Mysis Health Systems EMR system. Exhibit A shows materials published, on line, by Mysis, and providing information about the hardware requirements and functionality of the Mysis EMR system. The principles of the present invention are described herein in connection with a Mysis Healthcare Systems EMR system, and from that description the manner in which the principles of the present invention can be used with various types of EMR systems and methods will be apparent to those in the art.

An EMR template functionality for workflow management and workflow information capture, according to the principles of the present invention, is configured with the following characteristics; (a) user specific workflow specific structured language options (embodied in a “glossary”), (b) the ability to be kept open to changes and new inputs over time, (c) the ability to enable selection of a user or user group as a responsible actor in the workflow, (d) the capability to distinguish the template from all other templates (without described workflow functionality) associated with the EMR, and (e) workflow specific searchable data fields.

Initially, it is believed useful to define several important terms that are used in this application. Specifically, reference to “workflow” or “process” would encompass an algorithm for sequencing of tasks performed by various agents to complete a given procedure in an organization (e.g. a medical office or other treatment environment). In the context of this invention, a workflow would always be designed to achieve processing intents of some sort, such as physical transformation, service provision, or information processing. Thus, a workflow or process, in the context of this application, implies a management (or administrative) function or type of information (such as scheduling or obtaining authorization for a procedure). Moreover, a process may be broader than a workflow in the sense that it has well-defined inputs, outputs and purposes, while the notion of workflow may apply more generally to any systematic pattern of activity. However, both a “workflow” and a “process”, in the context of this invention, are related to (and encompass) management or administrative operations of a medical office or other treatment environment.

by an “information event”, applicants mean an event, such as, e.g. (i) a patient is seen by a medical office or other treatment environment, (ii) a patient calls or e-mails the medical office or other treatment environment (iii) a patient is called or e-mailed by the medical office or other treatment environment, iv) patient information is communicated to or received from an insurance company, (v) communication between providers, or (vi) communication among provider's office staff in relation to administration (management) of patient's care. In applicants' experience, it is desirable that each time an information event occurs in connection with the management of a patient, the EMR template that is being maintained for the management of the workflow for that patient should be able to continuously represent the state of the workflow across the entire process the particular template refers to. Thus, the same template for the treatment of the patient for the condition is continuously updated, across the process the template refers to, as new encounters occur in connection with the treatment of the patient for the condition, until the treatment is completed.

In addition, reference to a template being configured to remain open (or enable recording of information events, patient workflow information capture, or to be maintained open, etc.) “across the process” means that the same template will remain active (i.e. the same template will be opened each time the medical office or other treatment environment seeks to record and or change patient workflow information relating to workflow management in regard to the process to which the template refers.

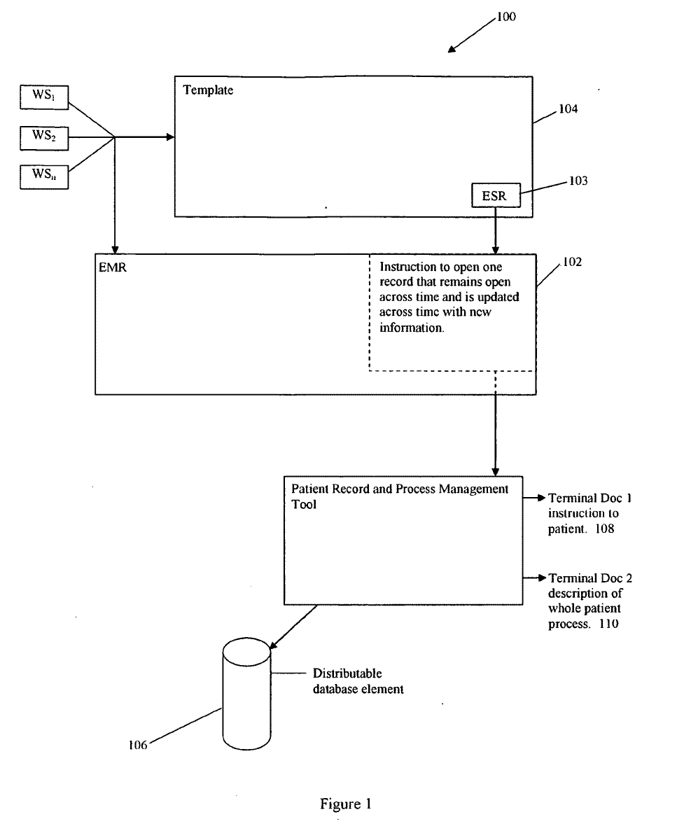

FIG. 1 schematically illustrates the overall structure of an EMR system 100 with an EMR template constructed according to the principles of the present invention. The system 100 includes an EMR processing module 102 that can be, e.g., the Mysis Healthcare system EMR processing module, and an EMR template structure 104 than enables workflow management and workflow information capture, in accordance with the principles of the present invention. The system 100 may include a template builder tool, which enables the EMR template 104 to be customized by a user. The EMR template 104, embodying the principles of the present invention, can be configured, e.g., using the template builder tool of the Mysis EMR system. Still further, the system 100 includes one or more workstations (WS1, WS2, WSn) each of which can interface with the EMR processing module 102 and the EMR template 104.

The modified EMR template (that includes the ESR feature 103 described below) embodies the workflow management and workflow information capture principles of the present invention, and provides the system 100 with new functionality. Specifically, the EMR template 104 is designed to provide (a) user configurable workflow specific structured language options, (b) the ability to be kept open to changes and new inputs across the process to which the template refers, keeping the workflow descriptive elements in synchrony with the state of the actual process to which the template refers, (c) the ability to enable selection of a user or user group as a responsible actor in the workflow, (d) the capability to distinguish the template from all other templates (without described workflow functionality) associated with the EMR (e.g. by means of the way the EMR template uses the “location” field, as described further below), and (e) workflow specific searchable data fields.

For example, as illustrated in FIG. 1, the template 104 is designed to enter workflow information to the EMR processing module 102 (through a template feature 103 referred to as an Electronic Scheduling Request, or ESR) in a manner that enables the EMR template 104 for a patient to be appended with new information and workflow specific elements kept in synchrony with the process the template refers to, so that each encounter relating to that patient is entered into the EMR, via the same EMR template. The template (with the ESR feature 103) not only provides patient medical information, but is also configured to capture workflow information (e.g. insurance authorization status, procedure scheduling status, etc.), which enables the EMR system to provide workflow management, e.g. the system can track a process over time, with regard to authorization and scheduling ordered for the patient, and thereby gives the medical office or other treatment environment an effective management tool to manage the medical office or other treatment environment's function and to provide effective patient care.

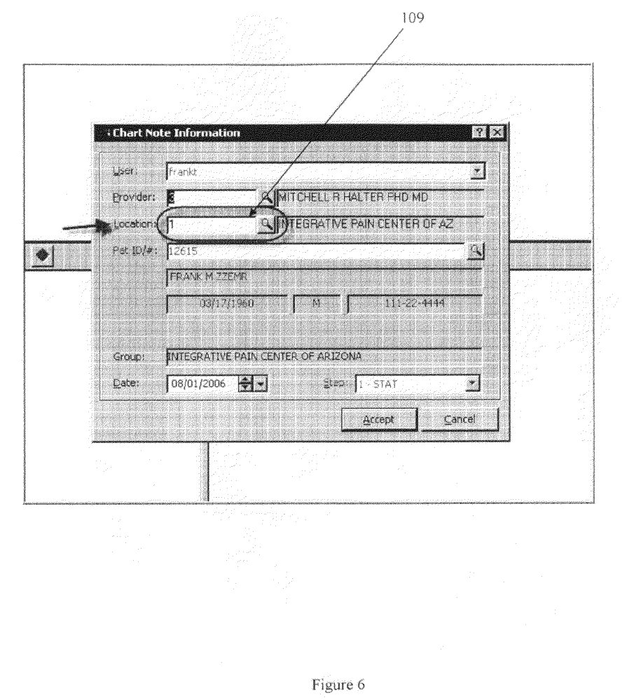

In the course of working with the Mysis EMR system, applicants recognized the value of causing such a system to maintain a single template for selected patient management processes so that each time an encounter occurs that is related to a patient management process, the encounter is recorded to the same template (as opposed to a template being closed and a new template opened each time there is a new encounter for the patient management process) and workflow specific data can be changed to match the status of the process referred to by the template. In addition, applicants recognized the value of an EMR template, with the features of the present invention, that can be distinguished from all other templates associated with the EMR. Thus, the EMR template 104 is maintained across the process to which the template refers, and distinguished from other templates in the EMR, by using a field in the Mysis EMR and a technique described below that can be appreciated from FIGS. 1 and 6. Specifically, applicants discovered that in the field 109 in the Mysis EMR system template labeled “location” rather than entering a physical location for a procedure to be carried out (as intended by the Mysis EMR) applicants could enter an unused number related to a code used by applicants to designate a type of process provided by applicants (e.g. a billable procedure, a workflow management function such as scheduling and/or authorization). Thus, that field 109 effectively became the EMR template component by which the same template could be maintained open, across the process to which the template referred, for a patient management function, and it also became a way of distinguishing the EMR template 104 from all other templates associated with the EMR. By entering that code in the “location” field 109, and by creating the user groups and work list processes described below as part of the EMR template 104, each time there is a new workflow management related encounter (e.g. an event such as an insurance authorization request, a scheduling request, a phone call to or from the patient, etc.) that workflow management related encounter, and workflow information related to that encounter, could be captured in the open EMR template 104, and could be processed by the user groups selected via the EMR template, as described further below.

In addition, as also schematically illustrated in FIG. 1, entry of workflow management information via the EMR template, as described herein, enables the EMR system 100 to function as a patient record and process management tool, and to create a database document 106 and two (2) terminal documents 108, 110 for each patient management process. In applicants' experience, it is desirable that each time an information event occurs in connection with a patient management process, the EMR template should be able to be updated, to receive new information and be kept in synchrony with the state of the process the template refers to. Thus, the same EMR template for that process is continuously updated, across the process to which the template refers, and enables the EMR to function as a process specific management tool, as a new information encounters occur in connection with a patient management process.

The ability to produce both a database document 106 and the two terminal documents 108, 110 from a single template is believed to be useful in improving the efficiency of the medical office or other treatment environment. Specifically, the terminal document 108 is provided to the patient at the time of an encounter in connection with a patient management process, and enables the patient to leave the medical office or other treatment environment with a document that explains the patient's treatment plan, including any procedures, follow ups, etc that are part of the treatment plan. The other terminal document 110 is an administrative history of the management of a procedure over time, as well as the complete processing the patient record has undergone, over time. Thus, the medical office or other treatment environment has such a complete record available to the medical office or other treatment environment, and that record is also available for other purposes, e.g. to send to (i) an insurance provider, (ii) another medical office or other treatment environment who needs the record to treat the patient, or (iii) other interested party that has a need to know not only the patient's diagnosis and treatment, but also complete processing recorded by the EMR template, across the process to which the template refers.

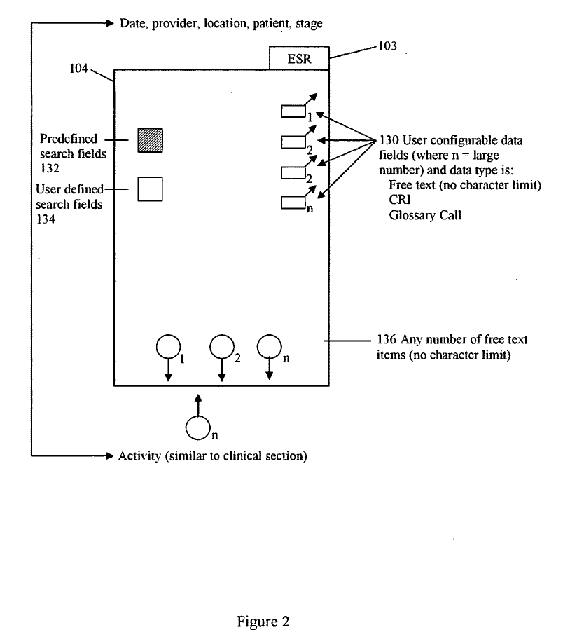

As schematically shown in FIG. 2, the basic structure of the template 104 includes user configurable fields 130, pre defined search fields 132, user defined search fields 134, free text fields 136, and the ESR template feature 103 that causes the same EMR template to be opened each time there is a new patient related encounter related to treatment of a patient for a condition.

The EMR template 104 is more specifically configured to enable capture of typical patient information (e.g. patient identification) that would normally be entered into an EMR system, and is also configured to enable capture of the workflow management the information that is particularly useful in managing the patient's treatment for a condition, over time. Specifically, the EMR template 104 is configured to enable entry or change in the EMR, of information events relating to the state of the management of a patient's treatment for the condition, including, e.g., any or all of “stat”, open, waiting response from outside agent, awaiting patient response, practice (provider) specific constraint, patient dependent constraint, whether procedure scheduled, needs to be reviewed and signed. These fields are workflow specific searchable data fields, and are shown in FIG. 2. In addition, the EMR template 104 is configured with workflow specific structured language options (also referred to as a glossaries or Clinical Reference Items in the Misys system) that enable selection and input of workflow specific information, and the EMR template has the ability to select a user group (also referred to as workgroup) who need to access the workflow information entered to the EMR, via the EMR template 104. These features are particularly useful to enable the EMR to be used in managing a patient's treatment for a condition.

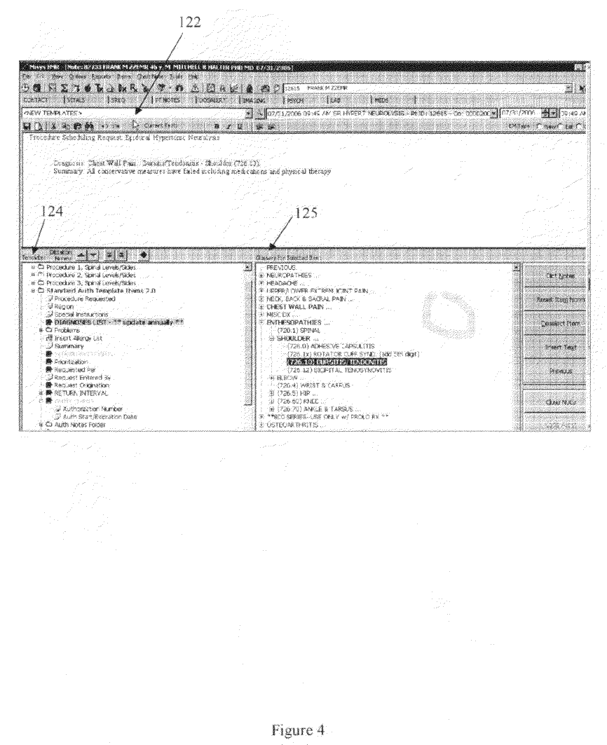

In addition, it is preferred that the EMR template 104 be configured to add any or all of the following additional information into the electronic record system (via data/information entry fields, as shown in FIGS. 4, 5, 7 and 8): (a) document origination, (b) special instructions, including a free text field that is unlimited in size, (c) allergies, (d) a summary text field that is unlimited in size, (e) a scheduling priority field, (f) prioritization in relation to other procedures, (g) patient return interval, (h) identification of follow up provider, (i) insurance authorization status, (j) scheduling notes that includes free text and automatic date and time stamp, (k) primary care physician, (l) referring source, (m) insurance provider, (n) place where the procedure is to be carried out, (o) confirmation of order provided to patient, with automatic time and date stamp, (p) list of standard questions related to surgical procedure, with prescribing physician in case of anti coagulant medication, (q) procedure being done multiple times, with time and date stamp for each procedure, (r) instructions for treating provider handed or mailed to patient, with date and time stamp, (s) whether procedure completed, It is also useful to note that the type of patient workflow information described above will generally include various elements may be appended to or changed across time (e.g. items b, d, i and j above), while other elements tend not to change once they have been entered. Also, there are some types of patient workflow data that might be changed to a different information state or changed (e.g. items e, f, g, h, m, and n) The user group would necessarily change as patient workflow information entered via the EMR template 104 is passed to different user stations or user activities.

As shown in FIG. 2, The EMR template 104 preferably comprises user configurable fields 130, pre defined search fields 132, user defined search fields 134, and free text fields 136. In applicants' preferred template, the search fields 132, 134, are related to workflow (or processing steps) that are recorded, over time, via the EMR template 104. The free text fields 136 are virtually unlimited in size, to enable a medical office or other treatment environment to record any information desired by the medical office or other treatment environment. The user configurable fields 130 include the work list and user group fields that are related to the workflow that can be performed by different workgroups of the medical office or other treatment environment and subsequently monitored by a medical office or other treatment environment to enable the medical office or other treatment environment to efficiently carry out that processing.

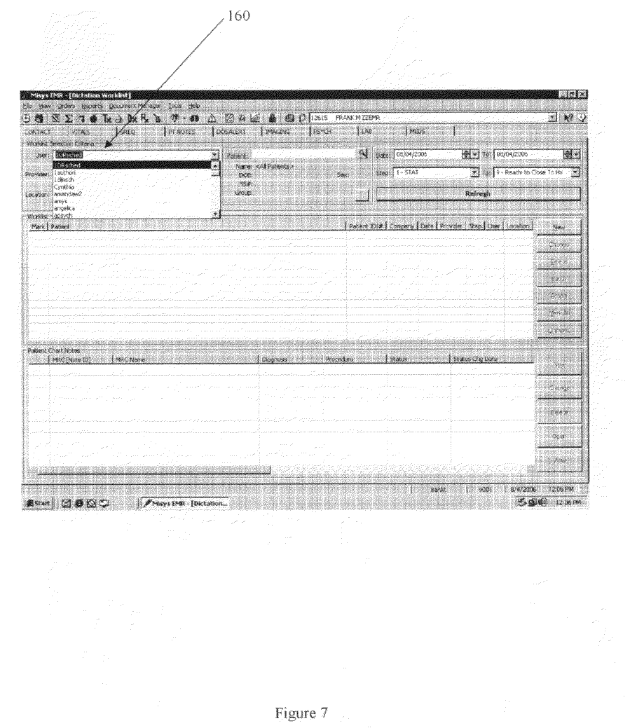

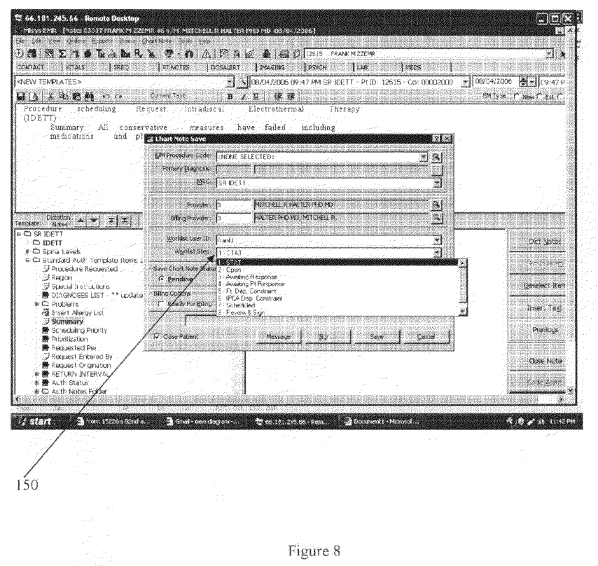

In the screen captures of FIGS. 4, 7 and 8, certain of the features added by the EMR template 104 of the present invention are shown. For example, FIG. 4 shows, in the screen area 122 labeled “New Templates” and all of the template entries that are shown below that screen area. In the area 124 labeled “Template” a medical office or other treatment environment can enter such information as document origination, special instructions, including a free text field that is unlimited in size, allergies, a summary text field that is unlimited in size, a scheduling priority field, prioritization in relation to other procedures, patient return interval, insurance authorization status, scheduling notes that includes free text and automatic date and time stamp, primary care physician, a user configurable workflow specific language option (i.e. a glossary) configured to be used to construct, e.g., text in selected text fields, and user group who need to access the EMR template. In addition, as illustrated in FIG. 7, in a field 160 named “work list selection criteria” there is an opportunity to select a workgroup, or user group, or particular members of a user group or work group, that may need to perform tasks in connection with a patient encounter that need to be recorded in the template. Moreover, as illustrated in FIG. 8, in a field 150 for a “work list step”, a medical office or other treatment environment can capture, via the template, workflow management information as to the state of the process, including “stat”, open, awaiting response (e.g. from an outside agent), awaiting patient (“pt”) response, patient (pt) dependent constraint, provider or practice (e.g. IPCA) dependent constraint, scheduled, needs to be reviewed and signed.

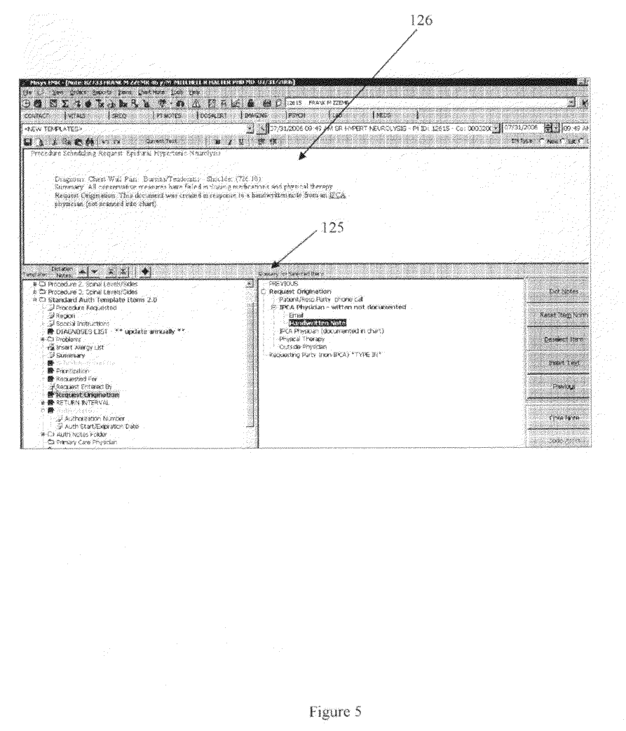

As shown in FIGS. 4 and 5, the user configurable workflow specific language options (found in glossary field 125, labeled “Glossary for Selected Item”) is embodied in a field that can be periodically updated by the medical office or other treatment environment, to enable the medical office or other treatment environment to carefully and accurately record the diagnosis, and workflow management information based on the patient encounter. For example, FIG. 5 shows a screen capture for a simulated patient encounter, and the types of events that can be used in the glossary to record the encounter. FIG. 5 also shows a text box 126 in which the glossary items selected are used to formulate a record of the patient encounter, in a manner that is both useful to the patient and the medical office or other treatment environment. Thus, as seen from FIG. 5, the glossary includes user configurable workflow specific language options that can be selected by a medical office or other treatment environment for preparing text for selected text fields, and such workflow specific language is configured to initiate predetermined workflow specific management information and instructions. The glossaries are structured hierarchical text building tools that return widely varying text strings via a hierarchical selection process, usually by making selections in a series of tree-and-branch layouts. The normal function is to return structured sentences (e.g. with workflow specific structured language options) related to the workflow management function. Glossaries are configurable by the end-user either by editing in a separate application or on-the-fly, capturing information that can be reused either in the same template or exported for use in another template.

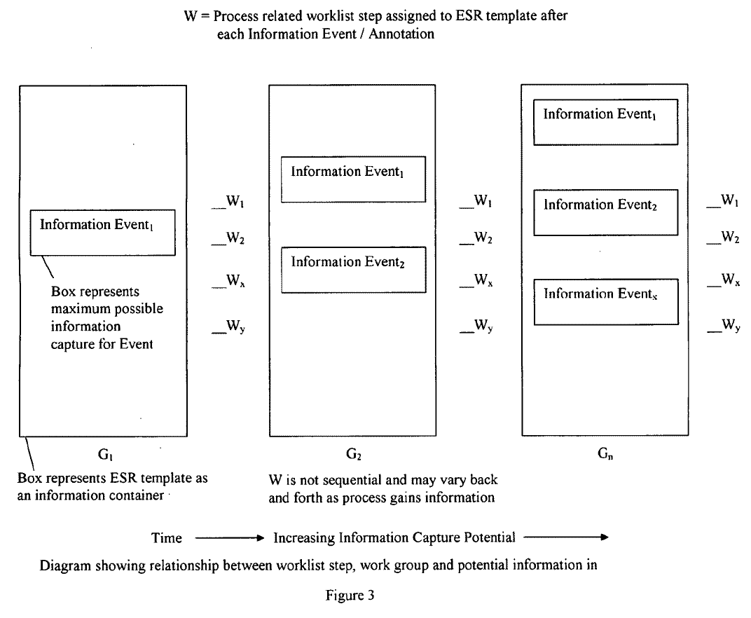

With the information that can be added via applicants' EMR template 104, the electronic medical records system can provide a particularly effective way of workflow management and documentation in connection with a patient management process. For example, using the EMR template of the present invention, and particularly the workgroup and work list fields of that template (FIGS. 7 and 8), the EMR system can be configured to provide an efficient way for workgroups to handle patient encounters in connection with a patient management process. Specifically, as seen from FIG. 3, there is a relationship between the work list steps, the work groups, and information events associated with the patient encounters. Such information events can include, e.g., (i) an examination by the medical office or other treatment environment, (ii) an authorization request to an insurance provider, (iii) a phone call to or from the patient, (iv) a scheduling request to the medical office or other treatment environment who will perform a procedure for a patient, or any other event that is initiated by the medical office or other treatment environment, the patient, an administrative station connected with the medical office or other treatment environment, an insurance provider, etc. As illustrated in FIG. 3, each work group (G1, G2, Gn) is connected with one or more information events. Each information event (Event 1, Event 2, Event n) is a step, procedure, etc connected to a work list task (w1, W2, Wn) that is part of the workflow management for a patient. Thus, an examining physician might make a diagnosis that requires insurance authorization to be obtained for a procedure, and once the authorization is obtained, the patient would need to be scheduled for the procedure. When the procedure is carried out, the patient may then need to be scheduled for follow up visits to the medical office or other treatment environment to determine the effectiveness of the procedure. When the examining physician has made an order, which is recorded in the template, the template is then effectively “handed off' (serially) to one or more of the workgroups, each of which has responsibility for certain of the events that need to be carried out for the patient (e.g. obtaining insurance authorization, scheduling the patient, etc.). The examining physician identifies the work list of events that have to be carried out, passes the template off to the workgroups that need to carry out the events. The template stays open at a work group station until the event that must be carried out by that workgroup station has been carried out in some fashion, so that the workgroup station can record what has been done to carry out the event, and pass the template to other workgroups that are associated with other events to be carried out by those other workgroups. By defining the workgroups and work list events as separate fields in the template (FIGS. 7, 8) , configuring the template so that a single template is maintained for a patient, across the process to which the template refers, across the tasks (i.e. events) that need to be carried out, and providing a user group as one of the fields, the electronic medical records system can be configured to enable a patient medical record that requires subsequent administrative (management) attention to be directed to one or more selected administrative stations and to remain at a selected administrative station until the record is passed from that administrative station to another selected administrative station.

It should also be noted that the work list tasks shown schematically in FIG. 3 are not necessarily sequential, so that workgroups can be carrying out various work list tasks, and passing the template back and forth between the workgroups, as the work list tasks are completed, or taken to a state to be passed to another workgroup. Since the template remains open, over time, for a patient, this process can be efficiently handled by the various workgroups.

In addition, with a template that is maintained, over time, and with the workgroup and work list fields described above, the EMR system can be configured to enable an administrator or provider to call up a status report that reports the administrative status of all or selected patient records, or all or selected records that relate to workgroups or events (especially workflow management related events), and that are of interest to the medical office or other treatment environment. For example, the medical office or other treatment environment can identify all matters that are awaiting insurance authorization, all procedure waiting to be scheduled, all procedures that have been performed and require follow up, etc. Moreover, the template of the present invention enables the EMR system to track the status and priority of a patient order as the patient order progresses through insurance authorization and scheduling, and to provide diagnosis-specific documents and checklists that can guide and remind a medical office or other treatment environment of relevant protocols and tests for certain conditions.

Applicants intend the concept of an electronic template, as described herein, to be particularly useful with a computer-based medical records program designed for use primarily by physicians, office staff and other care-givers, both in outpatient and inpatient settings. The electronic template is designed to allow fast, non-repetitious entry of data into an integrated clinical information system that enhances care. While a template for EMR's currently in use would be configured to produce a printable document of an information encounter, as advances are made in the use of EMR's such a template may also be used in entering patient workflow data of a type that includes other digital media such as audio and video recordings etc. The data captured can be of a medical, administrative or instructive nature and the information capture may be completed by any medical or administrative party with appropriate permissions.

Also, applicants note that methods of data entry via the template may include, keyboarding, mouse clicks, stylus selection on a touch sensitive screen, voice recording (for later transcription or direct inclusion of a recorded file), voice recognition (voice converted to text) and picture or video capture or other digital media. Any or all or all of these patient data entry methods may be used, simultaneously or serially, in the configuration of the template.

Additionally, applicants contemplate that those in the art will also recognize that the patient workflow information entry may include any or all of the following:

Clinical Reference Items (CRI's) ; data elements which capture strings (numeric, text or other digital data) which is stored in a table and can be accessed with other instances of the same CRI in the same or multiple documents.

History Items: any tabular data indexed to the patient which may be processed or queried and imported into an instance of a template usage for the purpose of displaying information relevant to what is being documented. Examples of this kind of item would be, a list of current medications, a list of medication allergies from a defined date range, a list of diagnoses, a list of procedures performed in relation to a certain problem, a list of lab results, a tabulation of free text items, etc.

Free Text Items: structured data elements which may hold preformatted text and/or allow entry of any type or length of text string. Data entered in a free text field may become a tabular data element which may be called in other documents or used only in the current document.

Other Data Items: generally, a template is meant to produce a printable document of an information encounter however as advances are made in the use of EMR's this is also beginning to encompass the inclusion of other digital media such as audio and video recordings etc. So, for instance, a hyperlink to a video of a video study could be included in an electronic document.

Work List: a database functionality which allows assignation of data to searchable fields which are descriptive of a party responsible for completing work on the document and/or the state of document completion.

With an EMR template, according to the principles of the present invention, the following workflow management processes have been demonstrated: (a) ordering a treatment procedure and tracking the process of authorization, scheduling, and follow up, and (b) ordering a diagnostic test and tracking the process of authorization, scheduling, and follow up. Moreover, the following workflow management processes can be implemented with an EMR template according to the principles of the present invention: (c) tracking the behavior of a suspected drug seeking patient over a series of encounters and appropriately docummenting interactions and providing decision support, (d) making a log of communications related to recommendations that a patient seek psychological consuling and which specifies actions to be taken in accordance with recorded interactions, and (e) capturing epidemiologic information on groups of patients having specific procedures or tests.

With the foregoing disclosure in mind, it is believed that various specific types of EMR templates that can be developed for workflow management and workflow information capture using the principles of the present invention, will be apparent to those in the art.

1. An EMR template enabled with user configurable workflow management capabilities, configured with the following characteristics;
a. user configurable workflow specific structured language options,
b. the ability to be kept open to changes and new inputs across the process to which the template refers,
c. the ability to enable selection of a user or user group as a responsible actor in the workflow,
d. the capability to distinguish the template from all other templates (without described workflow functionality) associated with the EMR, and
e. workflow specific searchable data fields.

2. An EMR template as defined in claim 1, wherein the workflow specific structured language options at least include structured language options relating to authorization and scheduling workflow management functions.
